(19) United States
(12) Patent Application Publication
(10) Pub. No.: US 2016/0072273 A1
(43) Pub. Date: Mar. 10, 2016

(54) POWER SUPPLY CIRCUIT

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: ZHANG-LONG PENG, Wuhan (CN); CHUN-SHENG CHEN, New Taipei (TW)

(21) Appl. No.: 14/526,054

(22) Filed: Oct. 28, 2014

(30) Foreign Application Priority Data
Sep. 9, 2014 (CN) 201410454673.4

(51) Int. Cl. H02H 3/20; H02M 3/156; H02M 1/088

(52) U.S. Cl. CPC H02H 3/202; H02M 1/088; H02M 3/156

(57) ABSTRACT

A power supply circuit includes an input circuit and a switch circuit. The switch circuit includes a first switch and a second switch. The input circuit receives a first DC voltage. A first terminal of the first switch receives a control signal. A second terminal of the first switch is grounded. A third terminal of the first switch is electrically coupled to a first terminal of the second switch. A second terminal of the second switch outputs a second DC voltage. A third terminal of the second switch is electrically coupled to the input circuit. When the second DC voltage is overvoltage, the first switch receives the control signal and turns off, the second switch turns off, the second terminal and the third terminal of the second switch are cut off, and the second terminal of the second switch can not output the second DC voltage.

### CROSS-REFERENCE TO RELATED APPLICATIONS

This application claims priority to Chinese Patent Application No. 201410454673.4 filed on Sep. 9, 2014, the contents of which are incorporated by reference herein.

### FIELD

The subject matter herein generally relates to a power supply circuit.

### BACKGROUND

Power supply circuits are widely used for providing power supply to electronic components on a motherboard. The power supply circuit converts a 220 volts AC voltage to a number of DC voltages which are provided to the electronic components.

### BRIEF DESCRIPTION OF THE DRAWINGS

Implementations of the present disclosure will now be described, by way of example only, with reference to the attached figures.

FIG. 1 is a block diagram of an embodiment of a power supply circuit.

FIG. 2 is a diagrammatic view of an embodiment of the power supply circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure is described in relation to a power supply circuit includes an input circuit and a switch circuit. The switch circuit includes a first switch and a second switch. The input circuit receives a first DC voltage. A first terminal of the first switch receives a control signal. A second terminal of the first switch is grounded. A third terminal of the first switch is electrically coupled to a first terminal of the second switch. A second terminal of the second switch outputs a second DC voltage. A third terminal of the second switch is electrically coupled to the input circuit. When the second DC voltage is overvoltage, the first switch receives the control signal and turns off, the second switch turns off, the second terminal and the third terminal of the second switch are cut off, and the second terminal of the second switch can not output the second DC voltage.

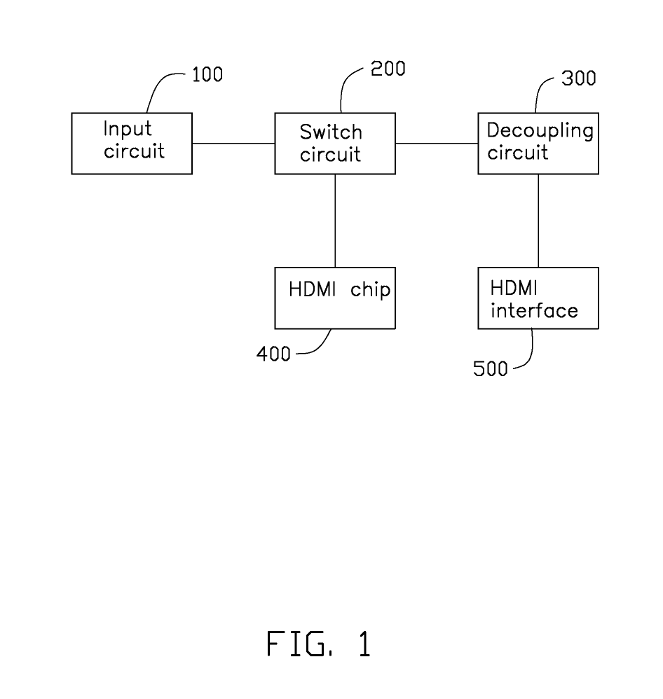

FIG. 1 illustrates an embodiment of a power supply circuit includes an input circuit 100, a switch circuit 200, and a decoupling circuit 300.

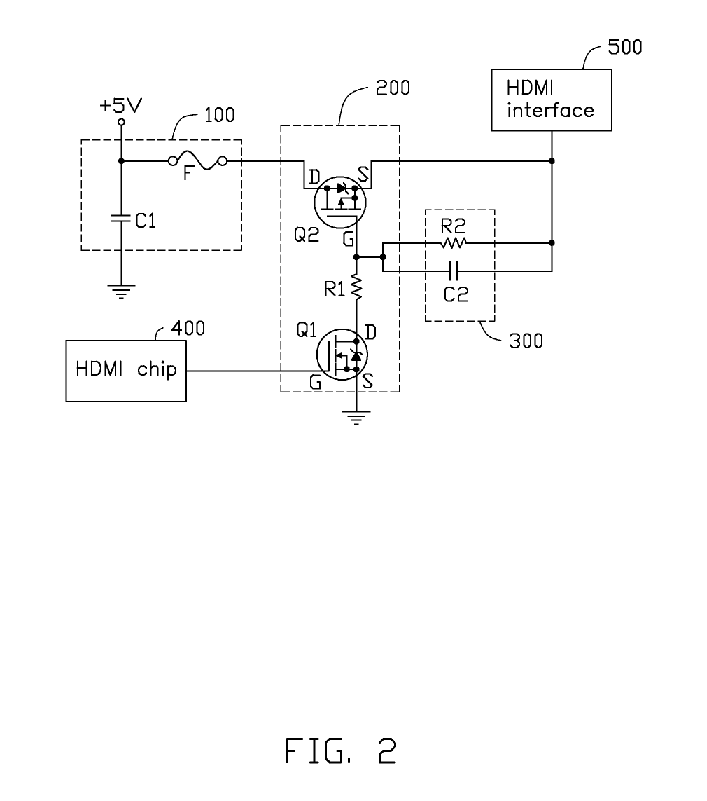

FIG. 2 illustrates a diagrammatic view of an embodiment of the power supply circuit. The input circuit 100 includes a fuse F and a first capacitor C1. A first terminal of the fuse F acting as an input terminal of the input circuit 100 receives a +5 volts first DC voltage. The first terminal of the fuse F is grounded via the first capacitor C1. A second terminal of the fuse F acting as an output terminal of the input circuit 100 is electrically coupled to the switch circuit 200. In one embodiment, a rated current of the fuse F is 1.25 amperes, and a rated voltage of the fuse F is 250 volts.

The switch circuit 200 includes a first MOSFET Q1, a second MOSFET Q2, and a first resistor R1. A gate of the first MOSFET Q1 receives a control signal from a HDMI chip 400. A source of the first MOSFET Q1 is grounded. A drain of the first MOSFET Q1 is electrically coupled to a gate of the second MOSFET Q2 via the first resistor R1. A drain of the second MOSFET Q2 is electrically coupled to the second terminal of the fuse F. A source of the second MOSFET Q2 outputs a second DC voltage to a HDMI interface 500.

In one embodiment, the first MOSFET Q1 is a N channel MOSFET, and the second MOSFET Q2 is a P channel MOSFET. The second DC voltage is a +5 volts display data channel voltage.

The decoupling circuit 300 includes a second resistor R2 and a second capacitor C2. A first terminal of the second resistor R2 and a first terminal of the second capacitor C2 are electrically coupled to the gate of the second MOSFET Q2. A second terminal of the second resistor R2 and a second terminal of the second capacitor C2 are electrically coupled to the source of the second MOSFET Q2.

In work, the HDMI chip 400 detects a status of the second DC voltage and outputs the control signal. When the second DC voltage is higher than +5 volts, the HDMI chip 400 outputs a low voltage level control signal. The gate of the first MOSFET Q1 receives the low voltage level control signal. The first MOSFET Q1 turns off. The gate of the second MOSFET Q2 is high voltage level. The second MOSFET Q2 turns off. The source and the drain of the second MOSFET Q2 are cut off. The source of the second MOSFET Q2 can not output the second DC voltage to the HDMI interface 500. The HDMI interface 500 is protected from being damaged by the second DC voltage.

When the second DC voltage is equal to +5 volts, the HDMI chip 400 outputs a high voltage level control signal. The gate of the first MOSFET Q1 receives the high voltage level control signal. The first MOSFET Q1 turns on. The gate of the second MOSFET Q2 is low voltage level. The second MOSFET Q2 turns on. The source and the drain of the second MOSFET Q2 are electrically connected. The source of the second MOSFET Q2 outputs the second DC voltage to the HDMI interface 500 and provides power supply to the HDMI interface 500.

During the second DC voltage is provided to the HDMI interface 500, the second resistor R2 and the second capacitor C2 of the decoupling circuit 300 eliminate sound voltages on the second DC voltage. A stability of the second DC voltage is remained.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A power supply circuit, comprising:
an input circuit comprising an input terminal and an output terminal; and
a switch circuit comprising a first switch and a second switch,
wherein the input terminal of the input circuit is configured to receive a first DC voltage, and the output terminal of the input circuit is coupled to the switch circuit;
a first terminal of the first switch is configured to receive a control signal;
a second terminal of the first switch is grounded;
a third terminal of the first switch is electrically coupled to a first terminal of the second switch;
a second terminal of the second switch is configured to output a second DC voltage;
a third terminal of the second switch is electrically coupled to the output terminal of the input circuit; and
the power supply circuit is configured such that when the second DC voltage is overvoltage, the first switch receives the control signal and turns off, the second switch turns off, the second terminal and the third terminal of the second switch are cut off, and the second terminal of the second switch is prevented from outputting the second DC voltage.

2. The power supply circuit of claim 1, wherein when the second DC voltage is normal, the first switch receives the control signal and turns on, the second switch turns on, the second terminal and the third terminal of the second switch are electrically connected, and the second terminal of the second switch outputs the second DC voltage.

3. The power supply circuit of claim 1, wherein the first switch and the second switch are MOSFETs; and the first terminal, the second terminal, and the third terminal are gate, source, and drain respectively.

4. The power supply circuit of claim 1, wherein the first switch is a N channel MOSFET, and the second switch is a P channel MOSFET.

5. The power supply circuit of claim 1, wherein the first DC voltage is +5 volts; and the second DC voltage is a +5 volts display data channel voltage.

6. The power supply circuit of claim 1, wherein the input circuit comprises a fuse and a first capacitor, a first terminal of the fuse acting as the input terminal of the input circuit is configured to receive the first DC voltage, the first terminal of the fuse is grounded via the first capacitor, and a second terminal of the fuse acting as the output terminal of the input circuit is electrically coupled to the third terminal of the second switch.

7. The power supply circuit of claim 1, wherein the switch circuit further comprises a first resistor; and the third terminal of the first switch is electrically coupled to the first terminal of the second switch via the first resistor.

8. The power supply circuit of claim 1, further comprising a decoupling circuit; the decoupling circuit comprises a second resistor and a second capacitor; a first terminal of the second resistor and a first terminal of the second capacitor are electrically coupled to the first terminal of the second switch; and a second terminal of the second resistor and a second terminal of the second capacitor are electrically coupled to the second terminal of the second switch.

9. The power supply circuit of claim 1, wherein the first terminal of the first switch is electrically coupled to a HDMI chip for receiving the control signal.

10. The power supply circuit of claim 1, wherein the second terminal of the second switch is electrically coupled to a HDMI interface for outputting the second DC voltage to the HDMI interface.

11. A power supply circuit, comprising:
an input circuit comprising an input terminal and an output terminal;
a switch circuit comprising a first switch and a second switch; and
a decoupling circuit comprising a second resistor and a second capacitor;
wherein the input terminal of the input circuit is configured to receive a first DC voltage, and the output terminal of the input circuit is electrically coupled to the switch circuit;
wherein a first terminal of the first switch is configured to receive a control signal; a second terminal of the first switch is grounded; a third terminal of the first switch is electrically coupled to a first terminal of the second switch; a second terminal of the second switch is configured to output a second DC voltage; a third terminal of the second switch is electrically coupled to the output terminal of the input circuit;
wherein a first terminal of the second resistor and a first terminal of the second capacitor are electrically coupled to the first terminal of the second switch; and a second terminal of the second resistor and a second terminal of the second capacitor are electrically coupled to the second terminal of the second switch; and
wherein when the second DC voltage is overvoltage, the first switch receives the control signal and turns off, the second switch turns off, the second terminal and the third terminal of the second switch are cut off, and the second terminal of the second switch can not output the second DC voltage.

12. The power supply circuit of claim 11, wherein when the second DC voltage is normal, the first switch receives the control signal and turns on, the second switch turns on, the second terminal and the third terminal of the second switch are electrically connected, and the second terminal of the second switch outputs the second DC voltage.

13. The power supply circuit of claim 11, wherein the first switch and the second switch are MOSFETs; and the first terminal, the second terminal, and the third terminal are gate, source, and drain respectively.

14. The power supply circuit of claim 11, wherein the first switch is a N channel MOSFET, and the second switch is a P channel MOSFET.

15. The power supply circuit of claim 11, wherein the first DC voltage is +5 volts; and the second DC voltage is a +5 volts display data channel voltage.

16. The power supply circuit of claim 11, wherein the input circuit comprises a fuse and a first capacitor, a first terminal of the fuse acting as the input terminal of the input circuit is configured to receive the first DC voltage, the first terminal of the fuse is grounded via the first capacitor, and a second terminal of the fuse acting as the output terminal of the input circuit is electrically coupled to the third terminal of the second switch.

17. The power supply circuit of claim 11, wherein the switch circuit further comprises a first resistor; and the third terminal of the first switch is electrically coupled to the first terminal of the second switch via the first resistor.

18. The power supply circuit of claim 11, wherein the first terminal of the first switch is electrically coupled to a HDMI chip for receiving the control signal.

19. The power supply circuit of claim 11, wherein the second terminal of the second switch is electrically coupled to a HDMI interface for outputting the second DC voltage to the HDMI interface.
